(19) United States
(12) Patent Application Publication
(10) Pub. No.: US 2025/0321432 A1
(43) Pub. Date: Oct. 16, 2025

(54) OPTICAL MULTIPLEXER, OPTICAL MULTIPLEXING COMPONENT, OPTICAL MULTIPLEXING COMPONENT WITH OPTICAL MODULATION FUNCTION, VISIBLE LIGHT SOURCE MODULE, OPTICAL ENGINE, AND XR GLASS

(71) Applicant: TDK CORPORATION, Tokyo (JP)

(72) Inventors: Yasuhiro TAKAGI, Tokyo (JP); Hiroki Hara, Tokyo (JP); Atsushi Shimura, Tokyo (JP)

(73) Assignee: TDK CORPORATION, Tokyo (JP)

(21) Appl. No.: 19/175,536

(22) Filed: Apr. 10, 2025

(30) Foreign Application Priority Data
Apr. 12, 2024 (JP) 2024-064587

(51) Int. Cl. G02B 27/10

(52) U.S. Cl. CPC G02B 27/102

(57) ABSTRACT

An optical multiplexer includes: an coupled MMI optical multiplexing part formed by coupling, from an input side, a first MMI optical multiplexing part and a second MMI optical multiplexing part having a width narrower than the first MMI optical multiplexing part; two optical input side optical waveguides connected to the first MMI optical multiplexing part; and a single optical output side optical waveguide connected to the second MMI optical multiplexing part, wherein one light input side optical waveguide is a two-color propagation light input side optical waveguide for propagating a combined laser light composed of two laser lights having different wavelengths, and the other is a one-color propagation light input side optical waveguide for propagating one laser light having a wavelength different from the two laser lights, and the second MMI optical multiplexing part is disposed on an extension of the one-color propagation light input side optical waveguide.

### CROSS-REFERENCES TO RELATED APPLICATIONS

This application relies for priority upon Japanese Patent Application No. 2024-064587 filed on Apr. 12, 2024, the entire content of which is hereby incorporated herein by reference for all purposes as if fully set forth herein.

### BACKGROUND

The present disclosure relates to an optical multiplexer, an optical multiplexing component, an optical multiplexing component with an optical modulation function, a visible light source module, an optical engine, and XR glasses.

Currently, glasses-type terminals are being considered for VR and AR. In particular, in recent years, retinal scanning displays that allow a user to view an image by forming an image of two-dimensionally scanned light on the user's retina have been attracting attention. In retinal scanning displays, three colors of visible light emitted from light sources such as LEDs (Light Emitting Diodes) and LDs (Laser Diodes) corresponding to the colors R (red), G (green), and B (blue) are generally combined on one optical axis. The combined three colors of visible light are transmitted to an image display unit. The image display unit scans the transmitted light two-dimensionally and causes it to enter the user's pupil. The incident light forms an image on the user's retina, allowing the user to view the image.

For example, Patent Document 1 discloses the configuration of a retinal projection display using a Mach-Zehnder type optical modulator.

### PRIOR ART DOCUMENTS

### Patent Documents

Patent Document 1: JP 6728596 B
Patent Document 2: JP 6787397 B
Patent Document 3: JP 6572377 B
Patent Document 4: JP 2012-48071 A
Patent Document 5: JP 2020-27170 A

### SUMMARY

In the retinal projection display disclosed in Patent Document 1, multiple optical waveguides are arranged close to each other at the exit section, but they are not multiplexed, so the optical axis for each wavelength is different, making it difficult to control the exiting light.

In addition, there is a demand for an optical multiplexer that can be connected to or integrated with a visible light modulator and that can adjust the RGB color balance, but at present, there has not yet been sufficient consideration given to realizing this idea.

However, in Patent Document 1, the light is simply brought close to the exit section, and is not multiplexed. Therefore, the optical axis for each wavelength is different, making the control of the emitted light complicated.

Also, Patent Document 2 discloses a visible light modulator using a lithium niobate film. Although there is a demand for an RGB optical multiplexer that can be connected to or integrated with a visible light modulator using a lithium niobate film, there has not yet been sufficient consideration given to realizing this idea.

Regarding multiplexing of visible light, directional couplers have generally been considered (see, for example, Patent Document 3). These are made of glass-based materials and have excellent stability, but when using a lithium niobate substrate with a large Δn, the coupling length becomes long and miniaturization is not possible.

Patent Documents 4 and 5 disclose the configuration of an RGB multiplexer using an MMI (multimode interferometer), but in both cases the materials used are glass-based, and no configuration using a lithium niobate film is disclosed.

An MMI optical multiplexer inputs multiple input signals using multiple waveguide ports on the optical input side, and on the optical output side, a single waveguide port is used for the output signal, with all the input signals being multiplexed and output as an output signal.

The MMI optical multiplexer is an optical multiplexer that utilizes the characteristic that a large number of modes generated for each wavelength within a wide optical multiplexer interfere with each other and form an image (converge) at a specific position.

The present disclosure has been made in consideration of the above-mentioned problems, and aims to provide an optical multiplexer, an optical multiplexing component, a visible light source module, and an optical engine that can be connected to or integrated with an optical modulator using a lithium niobate film, and that can be made smaller than conventional devices and have reduced optical loss.

In order to solve the above problems, the present disclosure provides the following means.

A first aspect of the present disclosure is an optical multiplexer that multiplexes laser lights having a plurality of different wavelengths, the optical multiplexer including: an MMI coupled optical multiplexing part formed by coupling, from an input side, a first MMI optical multiplexing part and a second MMI optical multiplexing part having a width narrower than a width of the first MMI optical multiplexing part; two optical input side optical waveguides connected to the first MMI optical multiplexing part; and a single optical output side optical waveguide connected to the second MMI optical multiplexing part, wherein, among the two light input side optical waveguides, one light input side optical waveguide is a two-color propagation light input side optical waveguide for propagating a combined laser light composed of two laser lights having different wavelengths, and the other light input side optical waveguide is a one-color propagation light input side optical waveguide for propagating one laser light having a wavelength different from the two laser lights, and the second MMI optical multiplexing part is disposed on an extension of the one-color propagation light input side optical waveguide.

A second aspect of the present disclosure is the optical multiplexer of the first aspect, wherein the width of the second MMI optical multiplexing part is ⅓ or more and ⅔ or less of the width of the first MMI optical multiplexing part.

A third aspect of the present disclosure is the optical multiplexer of either the first or second aspect, wherein the second MMI optical multiplexing part has a length of 10 μm or more.

A fourth aspect of the present disclosure is an optical multiplexer according to any one of the first to third aspects, wherein each of the two optical input waveguides and the single optical output waveguide has a tapered portion whose width increases continuously toward the MMI coupled optical multiplexing part.

A fifth aspect of the present disclosure is an optical multiplexer according to any one of the first to fourth aspects, including: a pre-MMI optical multiplexing part arranged on the input side of the MMI coupled optical multiplexing part; two pre-input side optical waveguides connected to the pre-MMI optical multiplexing part; and one pre-output side optical waveguide connected to the pre-MMI optical multiplexing part, wherein the pre-output side optical waveguide is connected to the two-color propagation optical input side optical waveguide.

A sixth aspect of the present disclosure is the optical multiplexer of any one of the first to fifth aspects, wherein all of the plurality of different wavelengths are visible light wavelengths.

A seventh aspect of the present disclosure is an optical multiplexing component including: a substrate made of a material different from lithium niobate; and a lithium niobate film formed on a main surface of the substrate, wherein the optical multiplexer according to any one of above-described aspects 1 to 6 is formed in the lithium niobate film.

Aspect eight of the present disclosure is a visible light source module including:
the optical multiplexing component according to the seventh aspect; and a plurality of visible light laser light sources configured to emit visible lights to be multiplexed by the optical multiplex component.

A ninth aspect of the present disclosure is an optical multiplexing component with optical modulation function, including: the optical multiplexing component according to the seventh aspect; and a Mach-Zehnder type optical modulator connected to the optical multiplexing component and guiding a plurality of visible lights emitted from a plurality of visible light laser light sources to the optical multiplexer.

A tenth aspect of the present disclosure is a visible light source module including: the optical multiplexing component with optical modulation function according to the ninth aspect; and a plurality of visible light laser light sources configured to emit visible lights to be multiplexed by the optical multiplex component with optical modulation function, wherein the plurality of visible light laser light sources are visible light laser light sources of red light, green light, and blue light.

An eleventh aspect of the present disclosure is an optical engine including: the visible light source module according to the eighth aspect; and a light scanning mirror configured to reflect the light emitted from the visible light source module at different angles to display an image.

A twelfth aspect of the present disclosure is an optical engine including: a visible light source module according to the tenth aspect; and a light scanning mirror configured to reflect the light emitted from the visible light source module at a different angle to display an image.

A thirteenth aspect of the present disclosure is XR glasses equipped with the optical engine according to the eleventh aspect.

A fourteenth aspect of the present disclosure is XR glasses equipped with the optical engine according to the twelfth aspect.

### Effect of the Invention

The present invention provides an optical multiplexer that can be connected to or integrated with an optical modulator using a lithium niobate film, and that can be made smaller than conventional devices and has reduced optical loss.

### BRIEF DESCRIPTION OF THE DRAWINGS

FIG. 1 is a schematic plan view illustrating an example of an optical multiplexer according to the present disclosure.

FIG. 2 is a schematic plan view showing another example of an optical multiplexer according to the present disclosure.

FIG. 3 is a schematic plan view showing another example of an optical multiplexer according to the present disclosure.

FIG. 4A is a diagram for explaining the principle of an MMI optical multiplexer, and is a conceptual diagram showing the relationship between the width W M and effective width We of the optical multiplexer and the single mode and higher-order modes.

FIG. 4B is a diagram for explaining the principle of an MMI optical multiplexer, and shows simulation results of electromagnetic field distribution at the cross sections of the waveguides of a single mode (TM0), a higher-order mode (TM1), and a higher-order mode (TM2).

FIG. 5A is a diagram for explaining the principle of an MMI optical multiplexer, showing the results of a simulation of the electromagnetic field distribution of red (R) light.

FIG. 5B is a diagram for explaining the principle of an MMI optical multiplexer, showing the results of a simulation of the electromagnetic field distribution of green (G) light.

FIG. 6A is a graph showing the relationship between the lengths and beat length of a first MMI optical multiplexing element and a second MMI optical multiplexing element and the output intensity for each of red (R) laser beams.

FIG. 6B is a graph showing the relationship between the lengths and beat length of the first and second MMI optical multiplexing elements and the output intensity for each of green (G) laser beams.

FIG. 7 is a schematic plan view of an optical multiplexing component according to the present disclosure.

FIG. 8 is a schematic cross-sectional view of the optical multiplexing component shown in FIG. 7 taken along line XX′.

FIG. 9 is a schematic cross-sectional view taken along the YZ plane when the cross section of an MMI optical multiplexing part is trapezoidal and has a slab section on the substrate side.

FIG. 10 is a schematic plan view of an optical multiplexing component with optical modulation function according to the present disclosure.

FIG. 11 is a schematic plan view of a visible light source module according to the present disclosure.

FIG. 12 is a schematic cross-sectional view of a part of the light source module shown in FIG. 11 cut along the XZ plane, depicting only a part near the joint.

FIG. 13A is a diagram for explaining an example of a method for driving an optical modulator.

FIG. 13B is a diagram for explaining another example of a method for driving the optical modulator.

FIG. 13C is a diagram for explaining another example of the method for driving the optical modulator.

FIG. 14 is a schematic plan view of a visible light source module according to the present disclosure.

FIG. 15 is a conceptual diagram for explaining an example of an XR glass of the present disclosure.

FIG. 16 is a conceptual diagram showing how an image is directly projected onto the retina by laser light emitted from a light source module in the XR glasses shown in FIG. 15.

FIG. 17 is a diagram showing parameters of a model used in a simulation.

FIG. 18A is a graph showing the loss of optical intensity after transmission through the MMI combined optical multiplexing part for each RGB wavelength, with the horizontal axis representing the length L1 of the first MMI optical multiplexing element, and the vertical axis representing the loss of optical intensity after transmission through the MMI combined optical multiplexing part for each RGB wavelength, for Example 1.

FIG. 18B is a graph showing the loss of optical intensity after passing through the MMI combined optical multiplexing part for each RGB wavelength, with the horizontal axis representing the length L1 of the first MMI optical multiplexing element, and the vertical axis representing the loss of optical intensity after passing through the MMI combined optical multiplexing part for each RGB wavelength, for Comparative Example 1.

### DETAILED DESCRIPTION

The present disclosure will be described in detail below with reference to the drawings as appropriate. The drawings used in the following description may show characteristic parts in an enlarged scale for the sake of convenience in order to make the characteristics easier to understand λ and the dimensional ratios of each component may differ from the actual ones. The materials, dimensions, etc. exemplified in the following description are merely examples, and the present disclosure is not limited thereto. They may be modified as appropriate within the scope of the effects of the present disclosure.

### [Optical Multiplexer]

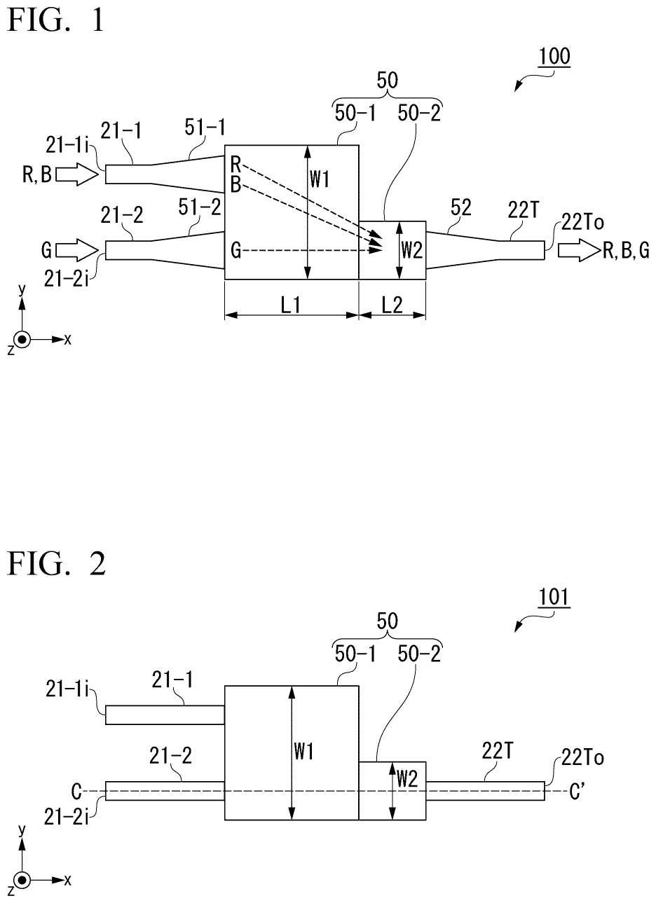

FIG. 1 is a schematic plan view showing an example of an optical multiplexer according to the present disclosure, and FIG. 2 is a schematic plan view showing another example of an optical multiplexer according to the present disclosure.

The optical multiplexer according to the present disclosure is a multi-mode interference (MMI) type optical multiplexer.

In this specification, an optical multiplexing part formed by coupling parts of different sizes (rectangular parts in a plan view) as shown in FIG. 1 may be referred to as an “MMI coupled optical multiplexing part.” Each part (rectangular part in a plan view) constituting an MMI coupled optical multiplexing part is referred to as an “optical multiplexing element.” In contrast, an optical multiplexing part consisting of one rectangular part may be referred to as an “MMI single optical multiplexing part.” An MMI single optical multiplexing part is composed of one optical multiplexing element. The MMI coupled optical multiplexing part and the MMI single optical multiplexing part may be collectively referred to as an MMI optical multiplexing part.

Furthermore, an optical multiplexing part in which MMI single optical multiplexing parts or MMI coupled type optical multiplexing parts are connected via optical waveguides may be referred to as an “MMI combined optical multiplexing part”. In addition, with regard to the “MMI combined optical multiplexing part”, depending on the number of optical waveguides to be connected, a configuration in which two MMI single optical multiplexing parts or MMI coupled optical multiplexing parts are connected may be referred to as a two-stage MMI combined optical multiplexing part (or simply, a two-stage MMI optical multiplexing part), a configuration in which three are connected may be referred to as a three-stage combined optical multiplexing part (or simply, a three-stage MMI optical multiplexing part), and a configuration in which multiple parts are connected may be referred to as a multiple-stage combined optical multiplexing part (or simply, a multiple-stage MMI optical multiplexing part). A configuration in which no combining is performed may be referred to as a one-stage MMI single optical multiplexing part or a one-stage MMI coupled optical multiplexing part. The one-stage MMI single optical multiplexing part and the one-stage MMI coupled optical multiplexing part may be collectively referred to as a one-stage MMI optical multiplexing part.

The optical multiplexer 100 shown in FIG. 1 is an optical multiplexer that multiplexes laser lights having different wavelengths. It includes an MMI coupled optical multiplexing part 50 formed by coupling, from the input side, a first MMI optical multiplexer (first MMI optical multiplexing element) 50-1 and a second MMI optical multiplexing part (second MMI optical multiplexing element) 50-2 having a width W2 narrower than the width W1 of the first MMI optical multiplexing part 50-1. It also includes two optical input-side optical waveguides 21-1 and 21-2 connected to the first MMI optical multiplexing part 50-1, and a second MMI optical multiplexing part (second MMI optical multiplexing element) 50-2 connected to the second MMI optical multiplexing part 50-2. It also includes one optical output side optical waveguide 22 connected to the first optical input side optical waveguide 21-1, wherein one of the two optical input side optical waveguides 21-1, 21-2 is an optical input side optical waveguide 21-1 for two-color propagation for propagating a combined laser light composed of two laser lights having different wavelengths, and the other optical input side optical waveguide is an optical input side optical waveguide 21-2 for one-color propagation for propagating one laser light of a wavelength different from the two laser lights. The second MMI optical combining section 50-2 is disposed on an extension line of the optical input side optical waveguide 21-2 for one-color propagation.

The optical multiplexer 100 is a 2×1 type (two input ports, one output port) optical multiplexer having two optical inlets (a first optical inlet 21-li, a second optical inlet 21-2i) and one optical outlet 22To.

In FIG. 1, the X direction is the direction in which the light input side optical waveguide extends, the Y direction is the direction perpendicular to the X direction, and the Z direction is the direction perpendicular to the plane formed by the X and Y directions.

By configuring the 2×1 type MMI coupled optical multiplexing part 50 in such a manner that the optical multiplexing elements are coupled in a stepped manner, it is possible to improve the deviation in the margin of multiplexing loss relative to the length of the optical multiplexing elements, as will be described in detail later.

In the case of the optical multiplexer 100 shown in FIG. 1, which is an optical multiplexer that combines visible light RGB laser beams as multiple different wavelengths, the two laser beams propagating in the optical input side optical waveguide 21-1 for two-color propagation are shown as R (red) and B (blue) and the two laser beams propagating in the optical input side optical waveguide 21-2 for one-color propagation as G (green). This combination is an example and is not limited to this combination.

It is also not limited to RGB of visible light as a plurality of different wavelengths.

It is preferable that the width W2 of the second MMI optical multiplexing part 50-2 is ⅓ or more and ⅔ or less of the width W1 of the first MMI optical multiplexing part 50-1.

The length L2 of the second MMI optical multiplexing part 50-2 is preferably m or more. The upper limit of the length of the second MMI optical multiplexing part 50-2 can be set to, for example, 10 to 200 μm.

The width W1 of the first MMI optical multiplexing part 50-1 can be set to, for example, 3 to 10 μm.

The second MMI optical multiplexing part 50-2 being arranged on an extension of the single-color propagation light input side optical waveguide 21-2 means that a virtual line passing through the center of the width of the second MMI optical multiplexing part 50-2 overlaps with a virtual line CC′ passing through the center of the width of the single-color propagation light input side optical waveguide 21-2, or that they overlap with a deviation smaller than ⅓ of the width W2 of the second MMI optical multiplexing part 50-2 (see FIG. 2).

In the optical multiplexer 100 shown in FIG. 1, the two optical input side optical waveguides 21-1, 21-2 have tapered sections 51-1, 51-2 at the portion where they connect to the first MMI optical multiplexing part 50-1, the width of which increases continuously as they approach the first MMI optical multiplexing part 50-1, allowing the inclination angle to be defined, and the single optical output side optical waveguide 22 has a tapered section 52 at the portion where they connect to the first MMI optical multiplexing part 50-1, the width of which increases continuously as they approach the second MMI optical multiplexing part 50-2, allowing the inclination angle to be defined.

When the cross sections perpendicular to the extension direction of the optical input side optical waveguides 21-1, 21-2 and the optical output side optical waveguide 22 are rectangular or trapezoidal (the upper base is smaller than the lower base), for example, if the width of the upper surface of the optical input side optical waveguides 21-1, 21-2 and the optical output side optical waveguide 22 is 0.3 to 1.2 μm, the tapered sections 51-1, 51-2, 52 have a starting width of 0.3 to 1.2 m, the width of the portion connected to the MMI optical multiplexing element can be, for example, 0.5 to 2.5 μm, and the length of the tapered section can be, for example, 10 to 500 μm.

The following effects can be obtained by providing a tapered portion at the input/output port connected to the MMI optical multiplexing element. The optical input side optical waveguide and the optical output side optical waveguide connected to the MMI optical multiplexing element are set to propagate single mode (zeroth mode, fundamental mode) laser light, and the MMI optical multiplexing element is set to propagate multimode (zeroth mode to higher mode). Therefore, when the light is input from the optical input side optical waveguide to the MMI optical multiplexing element and output from the MMI optical multiplexing element to the optical output side optical waveguide, a coupling loss occurs due to mode mismatch between the input single mode and the multimode. On the other hand λ when a tapered portion is provided at the input/output port, the mode mismatch between the single mode and the multimode is alleviated, and the coupling loss is reduced. The wider the width of the tapered portion, the more the mode mismatch is alleviated, and the greater the reduction in coupling loss.

The optical multiplexer according to the present disclosure is not limited to a configuration in which the optical input side optical waveguide and the optical output side optical waveguide have tapered portions, and may be a configuration in which the optical input side optical waveguide and the optical output side optical waveguide do not have tapered portions, as in the optical multiplexer 101 shown in FIG. 2.

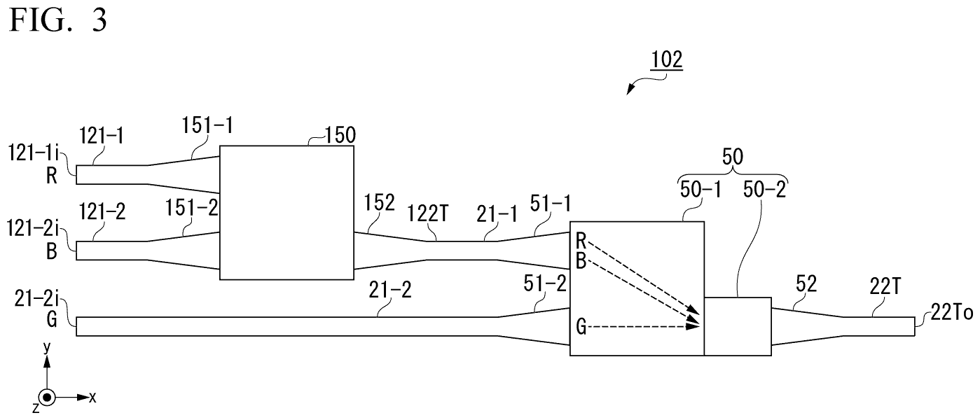

FIG. 3 shows an optical multiplexer having an MMI optical multiplexing part for producing multiplexed light of two laser beams propagating through the two-color propagation light input side optical waveguide 21-1 of the optical multiplexer 100 shown in Figure

In addition to the optical multiplexer 100 shown in FIG. 1, the optical multiplexer 102 shown in FIG. 3 has a pre-MMI optical multiplexing part 150, which is placed on the input side of the MMI coupled optical multiplexing part 50, two pre-MMI input-side optical waveguides 121-1 and 121-2 that connect to the pre-MMI optical multiplexing part 150, and one pre-MMI output-side optical waveguide 122T that connects to the pre-MMI optical multiplexing part 150. -2, and one pre-optical output side optical waveguide 122T connecting to the pre-MMI optical multiplexing part 150, and the pre-optical output side optical waveguide 122T is connected to the optical input side optical waveguide 21-1 for two-color propagation. The pre-optical output-side optical waveguide 122T and the optical input-side optical waveguide 21-1 for two-color propagation are one piece and do not need to be divided.

In the optical multiplexer 102 shown in FIG. 3, the pre-MMI optical multiplexing part 150 is an MMI single optical multiplexing part, but may be an MMI coupled type optical multiplexing part.

The MMI coupled optical multiplexing part 50 and the pre-MMI optical multiplexing part 150 constitute a two-stage MMI combined optical multiplexing part connected via the pre-light output side optical waveguide 122T and the two-color propagation light input side optical waveguide 21-1.

The optical multiplexer 102 is a 3×1 type (three input ports, one output port) optical multiplexer having three optical input ports (a first optical input port 121-li, a second optical input port 121-2i, a third optical input port 21-2i) and one optical output port 22To.

In the optical multiplexer 102 shown in FIG. 3, the two pre-optical input side optical waveguides 121-1, 121-2 connected to the pre-MMI optical multiplexing part 150 have tapered sections 151-1, 151-2 whose width continuously increases as they approach the pre-MMI optical multiplexing part 150 at the portion where they connect to the pre-MMI optical multiplexing part 150, allowing the inclination angle to be defined, and the one pre-optical output side optical waveguide 122T connected to the pre-MMI optical multiplexing part 150 has a tapered section 152 whose width continuously increases as they approach the pre-MMI optical multiplexing part 150 at the portion where they connect to the pre-MMI optical multiplexing part 150, allowing the inclination angle to be defined. The two pre-light input side optical waveguides 121-1, 121-2 and the one pre-light output side optical waveguide 122T are not limited to a configuration having a tapered portion, and the light input side optical waveguide and the light output side optical waveguide may be configured not to have a tapered portion (see FIG. 2).

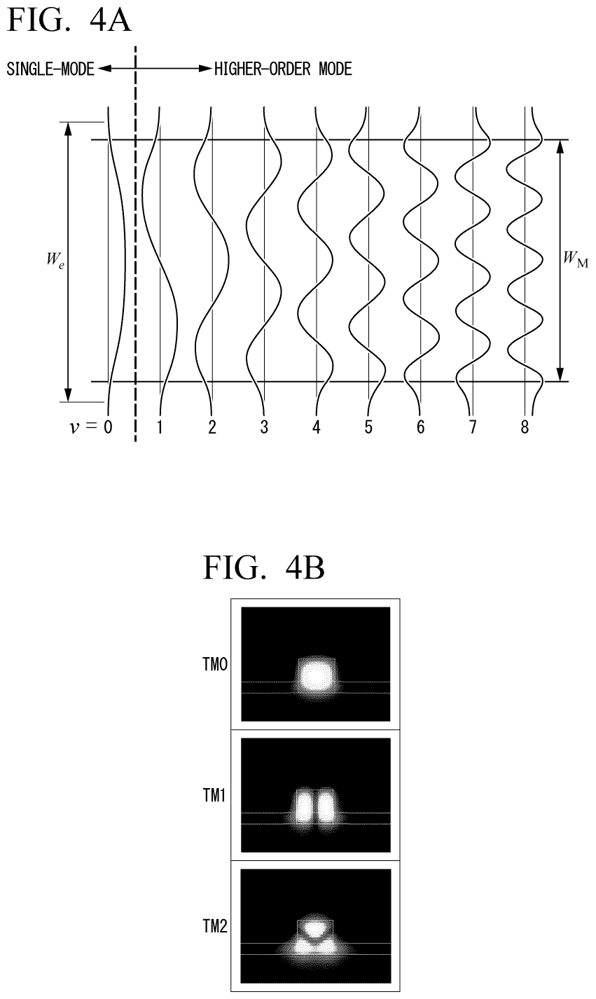

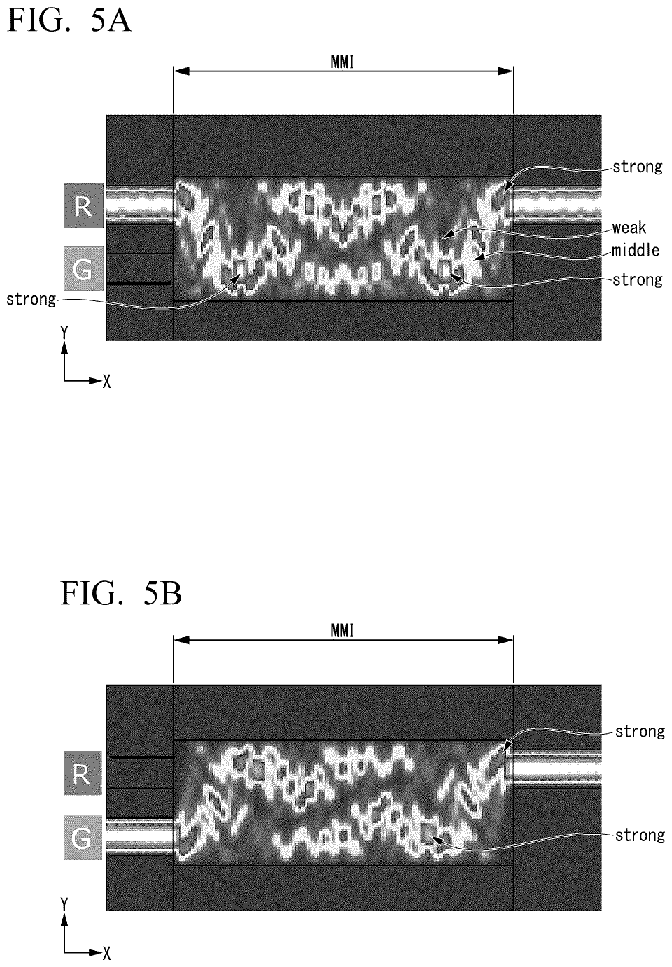

The principle of the MMI optical multiplexer will be explained using FIGS. 4A, 4B, 5A, and 5B. FIG. 4A shows the single mode (v=0) and higher order mode (v≥1) generated in the width WM of the MMI optical multiplexer. “We” is the effective width of the MMI optical multiplexer, and is approximated by the effective width of the MMI optical multiplexer taking into account the bleeding of the optical mode and the Goos-Henschen shift in the 0th order mode (fundamental mode). FIG. 4B is a diagram showing the simulation results of the electromagnetic field distribution of the cross section of the waveguide for each of the single mode (TM0), higher order mode (TM1), and higher order mode (TM2).

In an MMI optical multiplexer, multiple modes from the 0th order mode to higher order modes interfere with each other, and are characterized by forming an image (converging) at a specific position of the MMI optical multiplexer (a specified distance from the input end). It is known that the distance or period (beat length) Lπ between adjacent convergence points approximately follows formula (1). Formula (1) is the beat length Lπ between the two lower order modes, the zeroth order mode and the first order mode.

$${L}_{π} = \frac{π}{{β}_{0} - {β}_{1}} ≅ \frac{4 n {W}_{e}^{2}}{3 λ} \qquad ( 1 )$$

In formula (1), “We” is the effective width of the MMI optical multiplexer, n is the effective refractive index of the MMI, and λ is the wavelength of the input light. Each of β₀ and β₁, is the propagation constant of the 0th mode and the 1st mode, respectively. From formula (1), it can be seen that the beat length depends on the width and wavelength of the MMI optical multiplexer.

When the electromagnetic field distribution undergoes a phase change of 2π in all propagation modes generated within the MMI optical multiplexer, the optical intensity distribution coincides with the incident optical intensity distribution. The optical propagation distance required to achieve this coincidence (convergence) state is called the self-projection distance, and convergence is repeated at a period of LU after a certain propagation distance of 3Lπ/4.

FIGS. 5A and 5B show the results of a simulation of the electromagnetic field distribution of a cross section along the light propagation direction (x direction) of a 2×1 MMI optical multiplexer (R/G coupler) using simulation software (Fimmwave, Photon Design). In the simulation model, the y-direction position (coordinate) of the input side waveguide where red (R) light with a wavelength of 638 nm enters the optical multiplexer is the same as the y-direction position (coordinate) of the output side waveguide of the optical multiplexer, and the y-direction position of the input side waveguide where green (G) light with a wavelength of 520 nm enters the optical multiplexer is separated by a predetermined distance. The brighter the colored part, the stronger the interference between the modes (“strong” in the Figure), the darker the colored part, the weaker the interference between the modes (“weak” in the Figure), and the intermediate colored part, the intermediate position where the degree of interference between the modes is intermediate (“middle” in the Figure).

FIG. 5A shows the results of a simulation of the electromagnetic field distribution of red (R) light, and FIG. 5B shows the results of a simulation of the electromagnetic field distribution of green (G) light.

In FIGS. 5A and 5B, there is a part where strong interference occurs near the output port of the optical multiplexer, and it is preferable to set the length (length in the X direction) of the MMI optical multiplexer so that this position coincides as closely as possible (i.e., so that it approaches an integer multiple (least common multiple) of the beat length of each input wavelength as closely as possible). However, since the length of the MMI optical multiplexer is affected by the phase difference due to the input position of each input wavelength to the optical multiplexer, it is not possible to determine the length of the MMI optical multiplexer only by the integer multiple of the beat length of each input wavelength.

Therefore, the length of the optical multiplexer should be set to an integer multiple (least common multiple) of the beat length of each input wavelength, and it must be adjusted taking into account the effect of phase due to the input position of each input wavelength into the optical multiplexer.

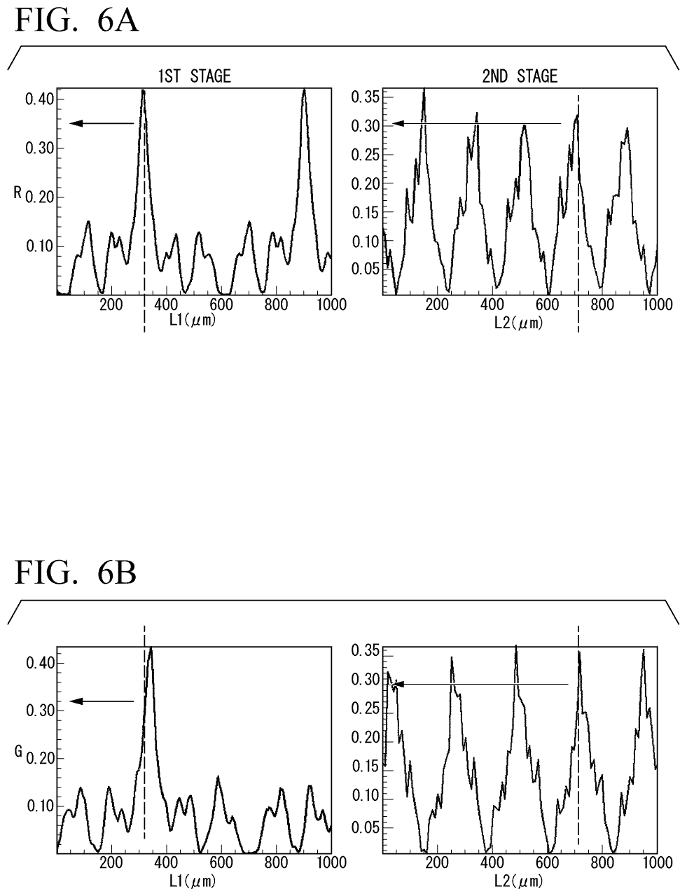

FIGS. 6A and 6B are graphs showing the relationship between the length and beat length of the first MMI optical multiplexing element (first stage) and the second MMI optical multiplexing element (second stage) and the output intensity for red (R) and green (G) laser light, respectively. The horizontal axis is the length (L1, L2) of the MMI optical multiplexing part, and the vertical axis is the optical intensity.

The beat lengths of red (R) and green (G) are different. When the length of the first MMI optical multiplexing element and the second MMI optical multiplexing element is about 700 μm, both red (R) and green (G) can be multiplexed with an output intensity of 0.3.

### [Optical Multiplexing Component]

The optical multiplexing component according to the present disclosure includes a substrate made of a material different from lithium niobate and a lithium niobate film formed on the main surface of the substrate, and the optical multiplexer according to the above embodiment is formed in the lithium niobate film. In the components described below, components having the same functions as those in the above embodiment may be given the same reference numerals and their description may be omitted. The lithium niobate film included in the optical multiplexing component according to the present disclosure may include an optical multiplexing part as shown in FIGS. 1 to 3.

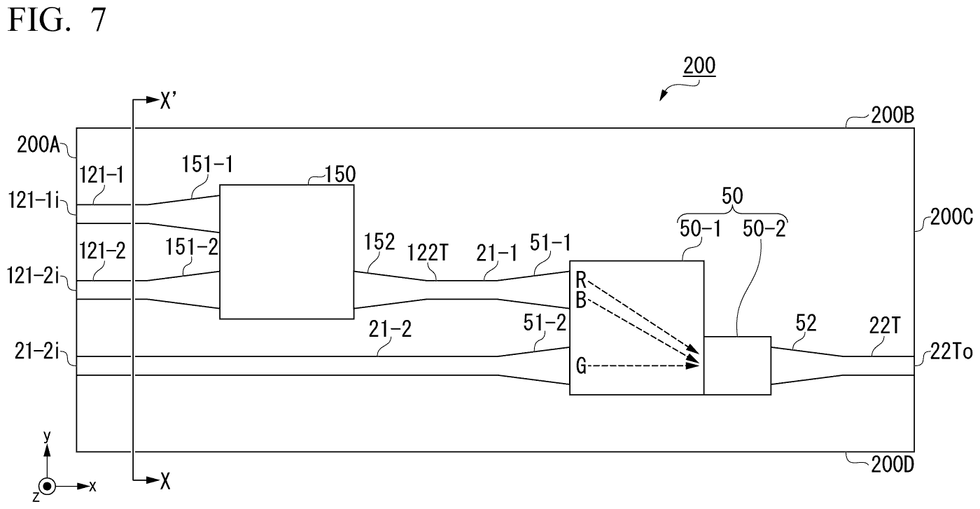

FIG. 7 is a schematic plan view of an optical multiplexing component according to the present disclosure.

The optical multiplexing component 200 shown in FIG. 7 has three light inlets (first light inlet 121-li, second light inlet 121-2i, third light inlet 21-2i) on the first side surface 200A and one light outlet 22To on the third side surface 200C opposite the first side surface 200A, but the light outlet 22To may also be provided on the second side surface 200B or the fourth side surface 200D adjacent to the first side surface 200A.

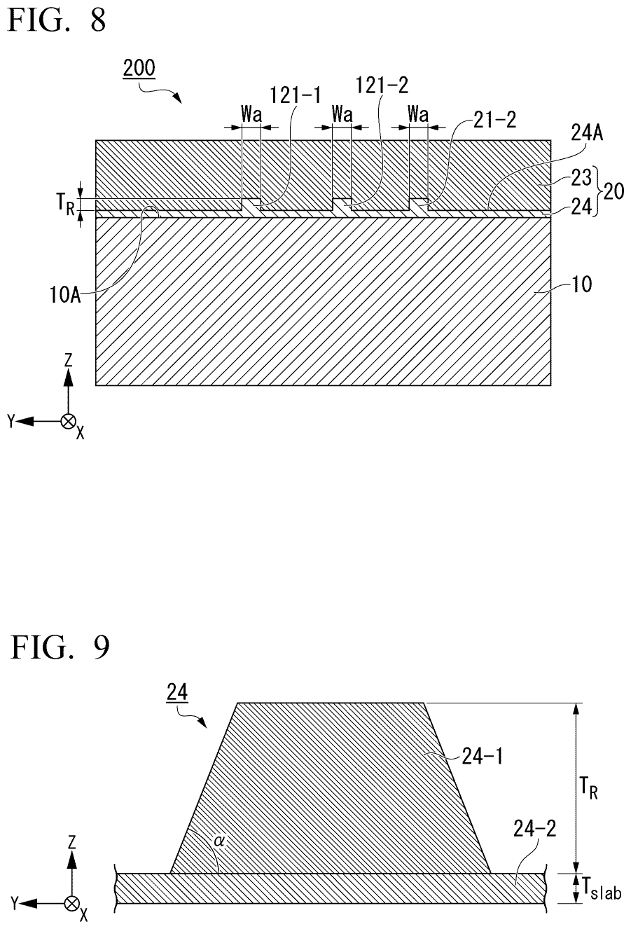

FIG. 8 is a schematic cross-sectional view of the optical multiplexing component 200 shown in FIG. 7 taken along the YZ plane (XX′ in FIG. 7).

The optical multiplexing component 200 shown in FIG. 8 includes a substrate 10 made of a material different from lithium niobate, and a lithium niobate film 24 formed on the main surface of the substrate 10, and the optical multiplexer shown in FIG. 1 is formed in the lithium niobate film 24.

FIG. 9, the lithium niobate film 24 may be configured to include a ridge 24-1 protruding from the first surface 24A and a slab layer 24-2 which is a portion other than the ridge. The ridge constitutes the optical input side optical waveguides 21-1, 21-2, 21-3, the first MMI optical multiplexing element 50-1, the second MMI optical multiplexing element 50-2, and the optical output side optical waveguide 22T. The lithium niobate film 24 is covered with a buffer film 23. The lithium niobate film 24 and the buffer film 23 are collectively referred to as the optical multiplexing functional layer 20.

When the optical multiplexing component of this embodiment is used in an eyeglass-type image display device, the thickness (T_{slab}) of the slab layer 24-2 is preferably 0.1 to 0.3 μm.

When the optical multiplexing component of this embodiment is used in an eyeglass-type image display device, the thickness (T_{R}) of the ridge 24-1 is preferably 0.5 to 1.0 μm, because if the thickness (T_{R}) of the ridge 24-1 is small, light does not propagate, and if it is large, the propagating light becomes multimode.

When the optical multiplexing component of this embodiment is used in an eyeglass-type image display device, the width (W_{R}) of the top surface of the ridge is preferably 0.3 to 1.2 μm, because if the waveguide width is small, the light does not propagate, and if it is large, the propagating light becomes multimode.

When the optical multiplexing component of this embodiment is used in an eyeglass-type image display device, the lower interior angle (a) of the ridge 24-1 having a trapezoidal cross section is 65° or more. This is because when the lower interior angle (inclination angle) becomes small, the propagating light becomes multimode.

In the optical multiplexing component 200, when the refractive index difference between the lithium niobate film and the buffer film is Δn, if the lithium niobate film is made of lithium niobate, Δn can be designed to be a larger value than when using materials such as glass, and the radius of curvature of the optical waveguide can be made smaller. Furthermore, by using a multi-mode interference optical multiplexing part, an increase in the coupling length can be prevented compared to when a directional coupler is used, thereby achieving both improved design freedom and miniaturization.

The substrate 10 may be, for example, a sapphire substrate, a Si substrate, or a thermally oxidized silicon substrate.

The substrate 10 is not particularly limited as long as it has a refractive index lower than that of a lithium niobate (LiNbO₃) film, but a sapphire single crystal substrate or a silicon single crystal substrate is preferred as a substrate on which a single crystal lithium niobate film can be formed as an epitaxial film. The crystal orientation of the single crystal substrate is not particularly limited, but since, for example, a c-axis oriented lithium niobate film has three-fold symmetry, it is desirable that the underlying single crystal substrate also has the same symmetry, and in the case of a sapphire single crystal substrate, a c-plane substrate is preferred, and in the case of a silicon single crystal substrate, a (111) plane substrate is preferred.

The lithium niobate film is, for example, a c-axis oriented lithium niobate film. The lithium niobate film is, for example, an epitaxial film epitaxially grown on the substrate 10. The epitaxial film is a single crystal film whose crystal orientation is aligned by the underlying substrate. The epitaxial film is a film having a single crystal orientation in the z direction and the xy in-plane direction, and the crystals are aligned in the x-axis, y-axis, and z-axis directions. Whether the film formed on the substrate 10 is an epitaxial film can be proved by, for example, checking the peak intensity and pole at the orientation position in 2θ-θ X-ray diffraction.

Specifically, when measured by 2θ-θ X-ray diffraction, all peak intensities other than the target plane are 10% or less, preferably 5% or less, of the maximum peak intensity of the target plane. For example, when the lithium niobate film is a c-axis oriented epitaxial film, the peak intensities other than the (00L) plane are 10% or less, preferably 5% or less, of the maximum peak intensity of the (00L) plane. Here, (00L) is a general designation for equivalent planes such as (001) and (002).

Moreover, the conditions for confirming the peak intensity at the orientation position described above only indicate the orientation in one direction. Therefore, even if the above conditions are obtained, if the crystal orientation is not aligned in the plane, the intensity of the X-rays will not increase at a specific angle position, and no poles will be observed. For example, when the lithium niobate film is a lithium niobate film, since LiNbO₃ has a trigonal crystal structure, there are three poles of LiNbO₃ (014) in the single crystal. In the case of lithium niobate, it is known that the epitaxial growth occurs in a so-called twin state in which crystals rotated 180° around the c-axis are symmetrically bonded. In this case, the three poles are symmetrically bonded to two, so there are six poles. In addition, when a lithium niobate film is formed on a silicon single crystal substrate with a (100) plane, the substrate is four-fold symmetric, so 4×3=12 poles are observed. In this disclosure, a lithium niobate film epitaxially grown in a twin state is also included in the epitaxial film.

The composition of lithium niobate is LiₓNbA_{y}O_{z}. “A” is an element other than Li, Nb, and O. “x” is 0.5 or more and 1.2 or less, and preferably 0.9 or more and 1.05 or less. “y” is 0 or more and 0.5 or less. “z” is 1.5 or more and 4.0 or less, and preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, and Ce, and two or more of these elements may be combined.

Furthermore, the lithium niobate film may be a lithium niobate single crystal thin film bonded onto a substrate.

[Optical Multiplexing Component with Optical Modulation Function]

The optical multiplexing component with optical modulation function according to this embodiment includes a substrate made of a material different from lithium niobate and a lithium niobate film formed on the main surface of the substrate, and the optical multiplexer according to the above embodiment and a Mach-Zehnder type optical modulator that is connected to the optical multiplexer and guides multiple visible light beams emitted from multiple visible light laser light sources to the optical multiplexer are integrated in the lithium niobate film. Regarding the components described below, components having the same functions as those in the above embodiment may be assigned the same reference numerals and their description may be omitted.

The lithium niobate film included in the optical multiplexing component with optical modulation function according to this embodiment may include any of the optical multiplexers shown in FIGS. 1 to 3.

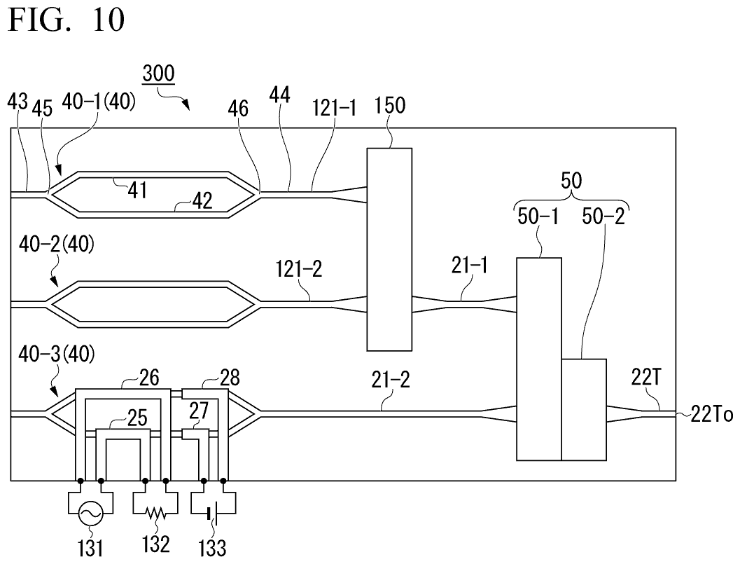

FIG. 10 is a schematic plan view of the optical multiplexing component with optical modulation function according to this embodiment.

The optical multiplexing component 300 with optical modulation function shown in FIG. 10 comprises a substrate 10 (see FIG. 8) made of a material other than lithium niobate, and a lithium niobate film 24 formed on the main surface of the substrate 10, and an optical multiplexer provided in the optical multiplexing component 300 with optical modulation function is formed in the lithium niobate film 24.

The optical multiplexing component 300 with optical modulation function includes the 3×1 type optical multiplexer 102 according to the above embodiment (see FIG. 3) and a Mach-Zehnder type optical modulator 40.

A known Mach-Zehnder type optical modulator or an optical waveguide can be used as the Mach-Zehnder type optical modulator 40, which splits (duplexes) an optical beam with a uniform wavelength and phase into two paired beams, gives each beam a different phase, and then combines (multiplexes) the beams. The intensity of the combined optical beam changes depending on the difference in phase.

Each of the Mach-Zehnder type optical waveguides 40-1, 40-2, and 40-3 shown in FIG. 10 includes a first optical waveguide 41, a second optical waveguide 42, an input path 43, an output path 44, a branching portion 45, and a coupling portion 46.

The output path 44 of the Mach-Zehnder type optical waveguide 40-1 is connected to the optical input side optical waveguide 21-1 of the first MMI optical multiplexing element 50-1. The output path 44 of the Mach-Zehnder type optical waveguide 40-2 is connected to the optical input side optical waveguide 21-2 of the first MMI optical multiplexing element 50-1. The output path 44 of the Mach-Zehnder type optical waveguide 40-3 is connected to the optical input side optical waveguide 21-3 of the first MMI optical multiplexing element 50-1.

The first optical waveguide 41 and the second optical waveguide 42 shown in FIG. 10 are configured to extend linearly in the x direction except for the vicinity of the branching portion 45 and the vicinity of the coupling portion 46, but are not limited to such a configuration. The lengths of the first optical waveguide 41 and the second optical waveguide 42 shown in FIG. 10 are approximately the same. The branching portion 45 is between the input path 43 and the first optical waveguide 41 and the second optical waveguide 42. The input path 43 is connected to the first optical waveguide 41 and the second optical waveguide 42 via the branching portion 45. The coupling portion 46 is between the first optical waveguide 41 and the second optical waveguide 42 and the output path 44. The first optical waveguide 41 and the second optical waveguide 42 are connected to the output path 44 via the coupling portion 46.

The electrodes 25 and 26 are electrodes that apply a modulation voltage to each of the Mach-Zehnder optical waveguides 40-1, 40-2, and 40-3 (hereinafter, sometimes simply referred to as “each Mach-Zehnder optical waveguide 40”). The electrode 25 is an example of a first electrode, and the electrode 26 is an example of a second electrode. One end of the electrode 25 is connected to a power source 131, and the other end is connected to a termination resistor 132. One end of the electrode 26 is connected to the power source 131, and the other end is connected to the termination resistor 132. The power source 131 is a part of a drive circuit that applies a modulation voltage to each Mach-Zehnder optical waveguide 40. For simplification of the drawing, the electrodes 25 and 26 are drawn only on the part of the Mach-Zehnder optical waveguide 40-3.

The electrodes 27 and 28 are electrodes that apply a DC bias voltage to each Mach-Zehnder optical waveguide 40. One end of the electrode 27 and one end of the electrode 28 are connected to a power source 133. The power source 133 is a part of a DC bias application circuit that applies a DC bias voltage to each Mach-Zehnder optical waveguide 40.

In the case where a DC bias voltage is superimposed on the electrodes 25 and 26, the electrodes 27 and 28 do not need to be provided. Also, ground electrodes may be provided around the electrodes 25, 26, 27, and 28.

### [Visible Light Source Module (First Embodiment)]

A visible light source module according to a first embodiment of the present disclosure includes an optical multiplexer according to the present disclosure, and a plurality of visible light laser light sources that emit visible light that is multiplexed by the optical multiplexer.

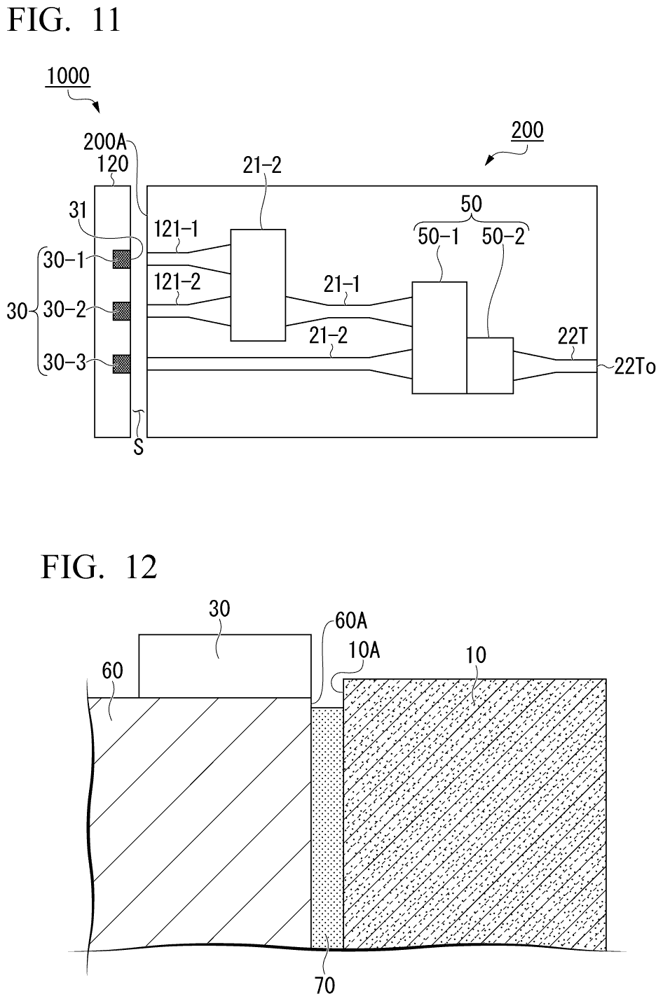

FIG. 11 is a schematic plan view of a visible light source module according to the present disclosure.

FIG. 11 includes an optical multiplexing component 200 including an MMI coupled optical multiplexing part 50 in which a first MMI optical multiplexing element 50-1 and a second MMI optical multiplexing element 50-2 are connected, and three visible light laser light sources 30 (30-1, 30-2, 30-3) that emit visible light multiplexed by the optical multiplexing component 200. The optical multiplexing component 200 includes a substrate 10 (see FIG. 8) made of a material different from lithium niobate, and a lithium niobate film 24 (see FIG. 8) formed on the main surface of the substrate 10, and has a side surface 200A.

Regarding the components shown in FIG. 11, components having the same functions as those described above are given the same reference numerals and the description thereof may be omitted.

Various laser elements can be used as the visible light laser light source 30. For example, commercially available laser diodes (LDs) for red light, green light, blue light, etc. can be used. For red light, light with a peak wavelength of 610 nm or more and 750 nm or less can be used, for green light, light with a peak wavelength of 500 nm or more and 560 nm or less can be used, and for blue light, light with a peak wavelength of 435 nm or more and 480 nm or less can be used.

In the visible light source module 1000, the visible light laser light sources 30-1, 30-2, and 30-3 are an LD that emits green light, an LD that emits blue light, and an LD that emits red light, respectively. The visible light laser light sources 30-1, 30-2, and 30-3 are arranged at intervals from each other in a direction approximately perpendicular to the emission direction of the light emitted from each LD, and are provided on the upper surface of the light source base 60 (see FIG. 12).

In the visible light source module 1000, the number of visible light laser light sources is exemplified as two and three, but the number is not limited to two or three, and may be four or more as long as there are multiple visible light laser light sources. The multiple visible light laser light sources may all have different wavelengths of emitted light, or there may be visible light laser light sources that emit the same wavelength of light. In addition, light other than red (R), green (G), and blue (B) may be used as the emitted light, and the mounting order of red (R), green (G), and blue (B) described using the drawings does not have to be in this order and can be changed as appropriate.

FIG. 12 is a schematic cross-sectional view taken along the XZ plane of a part of the light source module 1000 shown in FIG. 11. Only a part near the joint is depicted.

The light source 7 is mounted on the upper surface of a light source base 60. The light source base 60 may be common to all the light sources, or may be separate for each light source.

The light source base 60 is made of, for example, aluminum nitride (AlN), aluminum oxide (Al₂O₃), silicon (Si), or the like.

The light source base 60 and the optical waveguide substrate 10 on which the optical multiplexing function layer 20 is formed can be directly bonded via a metal layer 70. This configuration makes it possible to further reduce the size by eliminating spatial coupling or fiber coupling.

The bonding surface 60A of the light source base 60 and the bonding surface 10A of the optical waveguide substrate 10 to be bonded via a metal layer 70, the relative positions of the light source base 60 and the optical waveguide substrate 10 can be adjusted during manufacture to align the optical axis position of the laser light so that the optical axis of each light source 30 coincides with the axis of the input waveguide (active alignment).

Metal layer 70 may consist of multiple metal layers.

When the light source module of this embodiment is used in XR glasses, taking into consideration the amount of light required in the XR glasses, it is preferable that the gap (spacing) S between the bonding surface 60A of the light source base 60 and the bonding surface 10A of the optical waveguide substrate 10 be, for example, greater than 0 μm and less than 5 μm.

### (Driving Method)

An optical modulator can modulate input light into output light by using a high-frequency modulation voltage and a DC bias voltage. The operating point Vd of the optical modulator is adjusted by controlling the DC bias voltage Vdc. The operating point Vd is the voltage at the center of the modulation voltage amplitude Vpp. The half-wave voltage of the high-frequency modulation voltage is Vπ (RF).

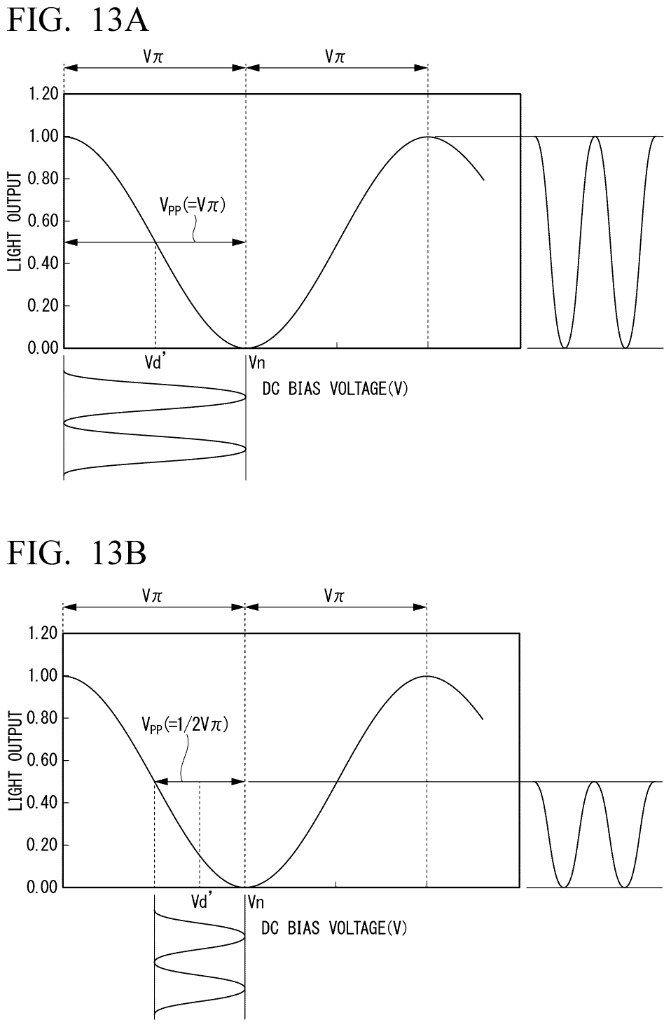

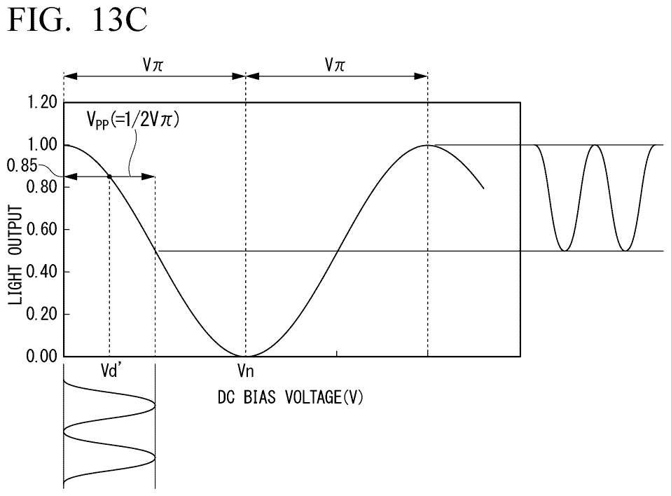

Each of FIGS. 13A to 13C is a diagram for explaining three examples of a method for driving an optical modulator.

In FIGS. 13A to 13C, the horizontal axis represents the DC bias voltage applied to the optical modulator, and the vertical axis represents the intensity of the optical output at the applied voltage. The applied voltage width Vpp is the difference between the minimum value (Vmin) and the maximum value (Vmax) of the applied voltage.

In FIG. 13A, if the operating point Vd′ is set so that the shift amount of the operating point voltage is (Vn-0.5V), the DC bias voltage can be set to approximately 0V. For example, if the applied voltage width Vpp of the modulation voltage Vm is a half-wave voltage Vπ (RF), a modulation voltage Vm in the range of (−½)Vπ(RF) to (½)Vπ(RF) is applied to the optical modulator. As shown in FIG. 13A, the optical output from the optical modulator is maximum when the modulation voltage Vm is (−½)Vπ(RF), is minimum when the modulation voltage Vm is (½)Vπ(RF), and is 50% of the maximum output when the modulation voltage Vm is 0V.

Similarly, using FIG. 13B, we will explain the optical modulation of an optical modulator in which the operating point Vd′ is set so that the shift amount of the operating point voltage is (Vn−0.25Vπ), and the applied voltage width Vpp of the modulation voltage Vm is controlled as (¼) wavelength voltage (½)Vπ(RF).

In this case, if the shift amount of the operating point voltage is set to (Vn-0.25Vπ), the operating point Vd′ can be set to a DC bias voltage of approximately 0 (V). A modulation voltage Vm corresponding to a range from (−¼)Vπ(RF) to (¼)Vπ(RF) is applied to the optical modulator. As shown in FIG. 13B, the optical output from the optical modulator is maximum when the modulation voltage Vm is (−¼)Vπ(RF), is minimum when the modulation voltage Vm is (¼)Vπ(RF), and the optical output when the modulation voltage Vm is 0V(Vd′) is 15% of the maximum output.

Similarly, using FIG. 13C, we will explain the optical modulation of an optical modulator in which the operating point Vd′ is set so that the shift amount of the operating point voltage is (Vn-0.75Vπ), and the applied voltage width Vpp of the modulation voltage Vm is controlled as (¼) wavelength voltage (½)Vπ(RF).

In this case, if the shift amount of the operating point voltage is set to (Vn-0.75Vπ), the operating point Vd′ can be set to a DC bias voltage of approximately 0 (V). A modulation voltage Vm corresponding to a range from (−¼)Vπ(RF) to (¼)Vπ(RF) is applied to the optical modulator. As shown in FIG. 13C, the optical output from the optical modulator is maximum when the modulation voltage Vm is (−¼)Vπ(RF), is minimum when the modulation voltage Vm is (¼)Vπ(RF), and is 85% of the maximum output when the modulation voltage Vm is 0V (Vd′).

### [Visible Light Source Module (Second Embodiment)]

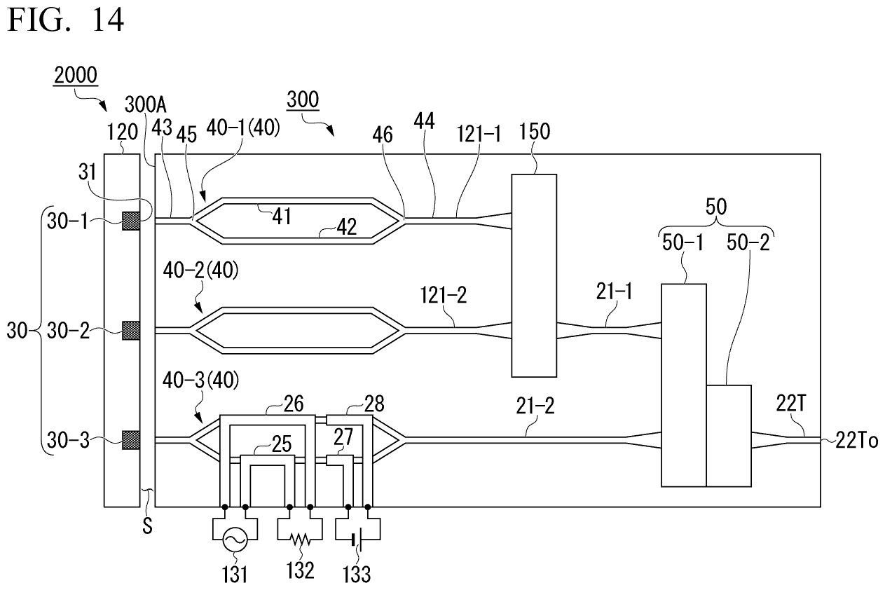

FIG. 14 is a schematic plan view of a visible light source module according to a second embodiment of the present disclosure. The visible light source module 2000 shown in FIG. 14 includes the optical multiplexing component 300 with optical modulation function shown in FIG. 10, and a plurality of visible light laser light sources 30 (30-1, 30-2, 30-3) that emit visible light multiplexed by the optical multiplexing component 300 with optical modulation function. The optical multiplexing component 300 with optical modulation function includes a substrate 10 (see FIG. 8) made of a material different from lithium niobate, a lithium niobate film 24 (see FIG. 8) formed on the main surface of the substrate 10, and has a side surface 300A.

Regarding the components shown in FIG. 14, components having the same functions as those described above are given the same reference numerals and the description thereof may be omitted.

The visible light source module 2000 has three Mach-Zehnder optical waveguides 40-1, 40-2, and 40-3, the same number as the number of visible light laser light sources 30-1, 30-2, and 30-3. The visible light laser light sources 30-1, 30-2, and 30-3 and the Mach-Zehnder optical waveguides 40-1, 40-2, and 40-3 are positioned so that light emitted from the visible light laser light sources is incident on the corresponding Mach-Zehnder optical waveguide.

The light source base 60 on which the visible light laser light sources 30-1, 30-2, and 30-3 are mounted and the substrate 10 on which the optical multiplexing function layer 20 having the optical multiplexing component 300 with optical modulation function is formed can be directly bonded via a metal bonding layer. This configuration makes it possible to further reduce the size by eliminating spatial coupling or fiber coupling.

In addition, during manufacturing, the relative positions of the light source base 60 and the substrate 10 can be adjusted to align the optical axis position of the laser light so that the optical axis of each visible light laser coincides with the axis of each input path 43 of the Mach-Zehnder type optical waveguides 40-1, 40-2, and 40-3 (active alignment).

The size of the optical multiplexing function layer 20 is, for example, 100 mm² or less. If the size of the optical multiplexing function layer 20 is 100 mm² or less, it is suitable for use in XR glasses such as AR glasses and VR glasses.

The optical multiplexing function layer 20 can be manufactured by a known method, for example, by using semiconductor processes such as epitaxial growth, photolithography, etching, vapor phase growth, and metallization.

When the visible light source module of the present disclosure is applied to XR glasses such as AR glasses or VR glasses, the width of the first MMI optical multiplexing element and the second MMI optical multiplexing element constituting the optical multiplexer is preferably, for example, about 5 to 15 μm, and the length thereof is preferably, for example, about 100 to 1000 μm.

For example, in a retinal projection display, in order to display an image in a desired color, it is necessary to independently modulate the intensity of each of the three colors of RGB that express visible light at high speed. If such modulation is performed only with a visible light laser light source (current modulation), the load on the IC that controls the modulation will be large, but it is possible to also use modulation (voltage modulation) by a Mach-Zehnder type optical modulator 40 (optical multiplexing component 300 with optical modulation function). In this case, rough adjustment may be performed with a current (visible light laser light source) and fine adjustment with a voltage (Mach-Zehnder type optical modulator 40), or rough adjustment may be performed with a voltage (Mach-Zehnder type optical modulator 40) and fine adjustment with a current (visible light laser light source). Since fine adjustment with voltage has better responsiveness, the former is adopted when responsiveness is important, and fine adjustment with current requires a lower current and therefore reduces power consumption, so it is preferable to adopt the latter when power consumption reduction is important.

### [Optical Engine and XR Glasses]

In this specification, an optical engine refers to a device that includes a plurality of light sources, an optical system including a multiplexing section that combines a plurality of light beams emitted from the plurality of light sources into a single beam of light, an optical scanning mirror that reflects the light emitted from the optical system at a different angle so as to display an image, and a control element that controls the optical scanning mirror.

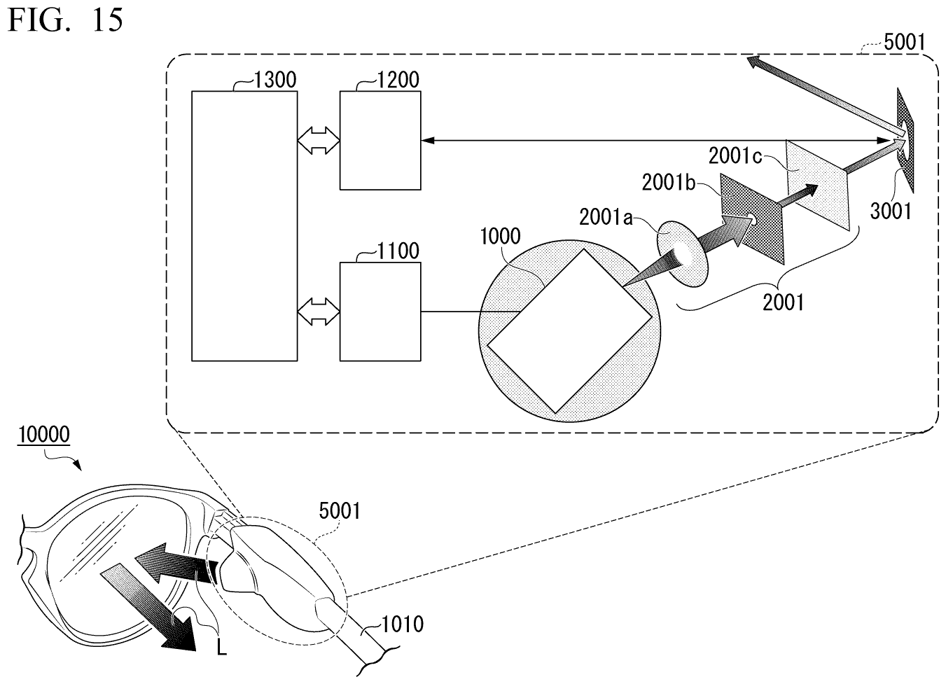

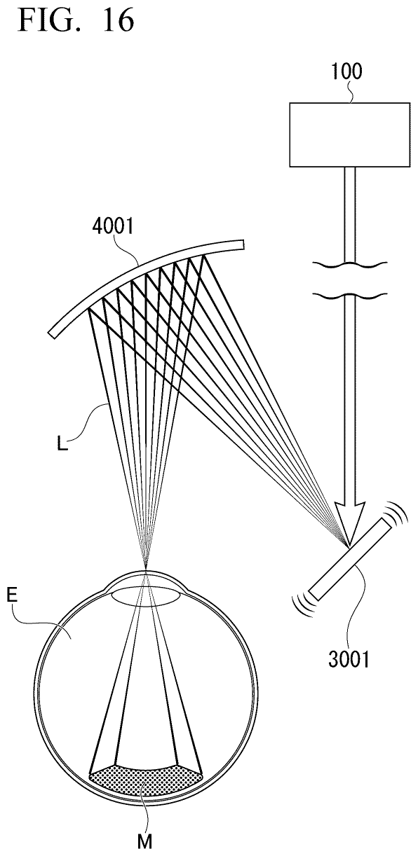

FIG. 15 is a conceptual diagram for explaining an example of the XR glasses of the present disclosure. FIG. 16 is a conceptual diagram showing a state in which an image is directly projected onto the retina by the laser light emitted from the light source module in the XR glasses shown in FIG. 15. The symbol L is an image display light.

The XR glasses (eyeglasses) 10000 of this embodiment are glasses-type terminals. XR is a general term for virtual reality (VR), augmented reality (AR), and mixed reality. The symbol L shown in FIG. 16 denotes image display light.

The XR glasses 10000 of this embodiment shown in FIG. 15 are configured such that the light source module 1000 according to the above-described embodiment is mounted on an optical engine 5001 installed on a frame 1010.

As shown in FIG. 15, the optical engine 5001 has a light source module 1000, an optical scanning mirror 3001, an optical system 2001 connecting the light source module 1000 and the optical scanning mirror 3001, a laser driver 1100, an optical scanning mirror driver 1200, and a video controller 1300 that controls these drivers.

For example, a MEMS mirror can be used as the optical scanning mirror 3001. In order to project a 2D image, it is preferable to use, as the optical scanning mirror 3001, a two-axis MEMS mirror that vibrates so as to reflect laser light by changing angles in the horizontal direction (X direction) and the vertical direction (Y direction).

The optical system 2001 optically processes the laser light emitted from the light source module 1000. As the optical system 2001, for example, one having a collimator lens 2001a, a slit 2001b, and an ND filter 2001c can be used. The optical system 2001 shown in FIG. 15 is an example, and other configurations may be used.

In the XR glasses 10000 of this embodiment shown in FIG. 15, as shown in FIG. 16, laser light R irradiated from the light source module 1000 attached to the frame 1010 is reflected by the light scanning mirror 3001, and further reflected by the lens 4001 of the XR glasses 10000, enters the human eyeball E as image display light L, and an image (video) can be directly projected onto the retina M.

The XR glasses 10000 of this embodiment are equipped with the light source module 1000 of this embodiment, and therefore have reduced electric field efficiency.

The above describes the embodiments of the present disclosure in detail with reference to the drawings. However, each configuration and combination thereof in each embodiment is merely an example, and addition, omission, substitution, and other modifications of the configuration are possible without departing from the spirit of the present disclosure.

### EXAMPLES

The present disclosure will be described in more detail below using examples, but the present disclosure is not limited to the examples shown below.

### <3-Input, 1-Output MMI Combined Optical Multiplexing Part>

A simulation was carried out to compare the coupling losses of the three colors of RGB light (loss of light intensity at the output after the light intensity at the input passes through the MMI combined optical multiplexing part) between the model of the three-input one-output MMI combined optical multiplexing part shown in FIG. 3 and the model of the three-input one-output MMI combined optical multiplexing part that differs only in that it does not have a second MMI optical multiplexing element. Fimmwave (Photon Design) was used as the simulation software.

### Example 1

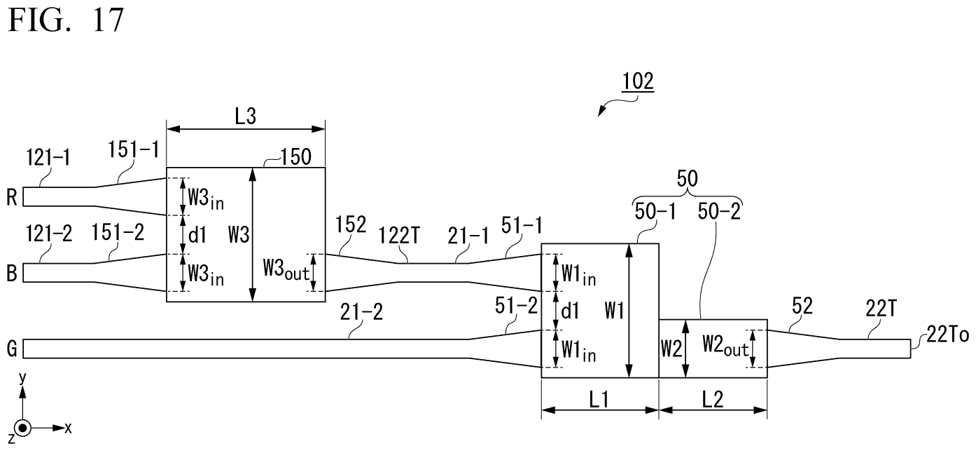

The dimensions of the MMI coupled optical multiplexing part 50 formed by coupling the first MMI optical multiplexing element 50-1 and the second MMI optical multiplexing element 50-2, and the pre-MMI optical multiplexing part 150 disposed on the input side of the MMI coupled optical multiplexing part 50, are as follows (see FIG. 17):

(Length and width of each component)
Length L1 of the first MMI optical multiplexing element: 680 μm
Width W1 of the first MMI optical multiplexing element: 5.6 μm
Length L2 of the second MMI optical multiplexing element: 90 μm
Width W2 of second MMI optical multiplexing element: 2.8 μm
Length L3 of pre-MMI optical multiplexing part: 525 μm
Width W3 of pre-MMI optical multiplexing part: 6 μm
Width of optical input waveguide W1ᵢₙ, W3ᵢₙ: 2 μm
Width of optical output waveguide W2ₒᵤₜ, W3ₒᵤₜ: 2 μm
Width of optical waveguide other than tapered section: 0.8 μm (common)

Widths of W1ᵢₙ and W3ᵢₙ of the optical input side optical waveguide (ridge) and the width W2ₒᵤₜ of the optical output side optical waveguide (ridge) are all widths of the parts connected to the MMI optical multiplexing part, and a model is adopted in which the width increases continuously from a predetermined position of the optical waveguide to the part connected to the MMI optical multiplexing part when viewed in a plane in the Z direction, and the part has a tapered shape for which the inclination angle can be defined. The length of the tapered section having a tapered shape is 50 μm, and gradually increases from a width of 0.8 μm, with the width of the part connected to the MMI optical multiplexing part being 2 μm (Wᵢₙ, Wₒᵤₜ). (Wavelength of the optical input side optical waveguide)
Wavelength of the optical input side optical waveguide 21-1: 637 μm (red R)
Wavelength of the optical input side optical waveguide 21-2: 455 μm (blue B)
Wavelength of the optical input side optical waveguide 21-3: 520 μm (green G) (Distance between adjacent optical input side optical waveguides)
Distance d1 between the upper surfaces of adjacent optical input side optical waveguides: 1.5 μm

As shown in FIG. 17, the distance d1 between the upper surfaces is the distance between the upper surfaces of the portions of the adjacent optical input side optical waveguides that are connected to the MMI optical multiplexing portion.

### Comparative Example 1

The model of the MMI combined optical multiplexing part of Comparative Example 1 was the same model as that of Example 1, and had the same parameters, except that the MMI optical multiplexing part corresponding to the MMI coupled optical multiplexing part 50 of Example 1 was an MMI single optical multiplexing part not equipped with a second MMI optical multiplexing element.

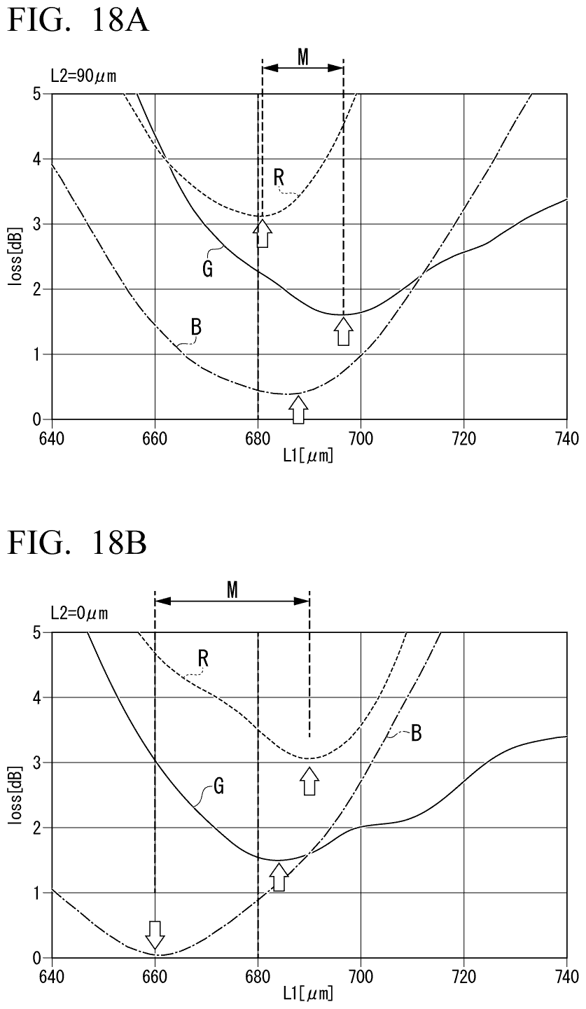

FIGS. 18A and 18B are graphs showing the length L1 of the first MMI optical multiplexing element on the horizontal axis and the loss of optical intensity after passing through the MMI combined optical multiplexing part for each RGB wavelength on the vertical axis for Example 1 and Comparative Example 1, respectively.

The white arrows indicate the minimum value of the loss in light intensity for each wavelength, and the range indicated by M indicates the magnitude of the deviation in the margin of the RGB multiplexing loss.

Comparing FIGS. 18A and 18B, it can be seen that the deviation in the margin of RGB multiplexing loss in Example 1, which is equipped with a second MMI optical multiplexing element, is significantly improved compared to Comparison Example 1, which is not equipped with a second MMI optical multiplexing element.

In Example 1 of FIG. 18A, the minimum value of the light intensity loss for each of the RGB colors is in the range of 688.5±6.5 μm, whereas in Comparative Example 1 of FIG. 18B, the minimum value of the light intensity loss for each of the RGB colors is 674.5±13.5 km. Therefore, it is possible to appropriately select L1 such that the loss of light intensity of the three RGB colors is reduced.

Also, when focusing on the minimum value of the light intensity loss of blue light, it was possible to shift it to L1=685 μm, which is close to the minimum values of red light and green light, in Example 1, compared to L1=661 μm in Comparative Example 1. Therefore, by adjusting the characteristics of the light intensity of blue light, which had caused an increase in the deviation of the conventional multiplexing loss margin, it was possible to improve the deviation of the RGB multiplexing loss margin.

While preferred embodiments of the invention have been described and illustrated above, it should be understood that these are exemplary of the invention and are not to be considered as limiting. Additions, omissions, substitutions, and other modifications can be made without departing from the scope of the present disclosure. Accordingly, the invention is not to be considered as being limited by the foregoing description, and is only limited by the scope of the appended claims.

### REFERENCE SYMBOL

10 Substrate
20 Optical multiplexing functional layer
24 Lithium niobate film
30 Visible light laser source
40 Mach-Zehnder type optical modulator
50 MMI optical multiplexer (MMI optical multiplexer)
50-1 First MMI optical multiplexing element
50-2 Second MMI optical multiplexing element
100, 101, 102 Optical multiplexer
150 MMI single optical multiplexer (MMI optical multiplexer)
200 Optical multiplexing component
300 Optical multiplexing component with optical modulation function
1000, 2000 Visible light source module
10000 XR Glasses

1. An optical multiplexer that multiplexes laser lights having a plurality of different wavelengths, the optical multiplexer comprising:
an MMI coupled optical multiplexing part formed by coupling, from an input side, a first MMI optical multiplexing part and a second MMI optical multiplexing part having a width narrower than a width of the first MMI optical multiplexing part;
two optical input side optical waveguides connected to the first MMI optical multiplexing part; and
a single optical output side optical waveguide connected to the second MMI optical multiplexing part,
wherein, among the two light input side optical waveguides, one light input side optical waveguide is a two-color propagation light input side optical waveguide for propagating a combined laser light composed of two laser lights having different wavelengths, and the other light input side optical waveguide is a one-color propagation light input side optical waveguide for propagating one laser light having a wavelength different from the two laser lights, and
the second MMI optical multiplexing part is disposed on an extension of the one-color propagation light input side optical waveguide.

2. The optical multiplexer according to claim 1, wherein the width of the second MMI optical multiplexing part is ⅓ or more and ⅔ or less of the width of the first MMI optical multiplexing part.

3. The optical multiplexer according to claim 1, wherein the second MMI optical multiplexing part has a length of 10 μm or more.

4. The optical multiplexer according to claim 1, wherein each of the two optical input waveguides and the single optical output waveguide has a tapered portion whose width increases continuously toward the MMI coupled optical multiplexing part.

5. The optical multiplexer according to claim 1, comprising:
a pre-MMI optical multiplexing part arranged on the input side of the MMI coupled optical multiplexing part;
two pre-input side optical waveguides connected to the pre-MMI optical multiplexing part; and
one pre-output side optical waveguide connected to the pre-MMI optical multiplexing part,
wherein the pre-output side optical waveguide is connected to the two-color propagation optical input side optical waveguide.

6. The optical multiplexer according to claim 1, wherein all of the plurality of different wavelengths are visible light wavelengths.

7. An optical multiplexing component comprising:
a substrate made of a material different from lithium niobate; and
a lithium niobate film formed on a main surface of the substrate,
wherein the optical multiplexer according to claim 1 is formed in the lithium niobate film.

8. A visible light source module comprising:
the optical multiplexing component according to claim 7; and
a plurality of visible light laser light sources configured to emit visible lights to be multiplexed by the optical multiplex component.

9. An optical multiplexing component with optical modulation function, comprising:
the optical multiplexing component according to claim 7; and
a Mach-Zehnder type optical modulator connected to the optical multiplexing component and guiding a plurality of visible lights emitted from a plurality of visible light laser light sources to the optical multiplexer.

10. A visible light source module comprising:
the optical multiplexing component with optical modulation function according to claim 9; and
a plurality of visible light laser light sources configured to emit visible lights to be multiplexed by the optical multiplexer with optical modulation function,
wherein the plurality of visible light laser light sources are visible light laser light sources of red light, green light, and blue light.

11. An optical engine comprising:
the visible light source module according to claim 8; and
a light scanning mirror configured to reflect the light emitted from the visible light source module at different angles to display an image.

12. An optical engine comprising:
a visible light source module according to claim 10; and
a light scanning mirror configured to reflect the light emitted from the visible light source module at a different angle to display an image.

13. XR glasses equipped with the optical engine according to claim 11.

14. XR glasses equipped with the optical engine according to claim 12.
